(19) United States
(12) Patent Application Publication
(10) Pub. No.: US 2015/0040719 A1
(43) Pub. Date: Feb. 12, 2015

(54) HYBRID POWERTRAIN PROVIDED WITH DOUBLE CLUTCH TRANSMISSION

(71) Applicant: Hyundai Motor Company, Seoul (KR)

(72) Inventor: Jong Hyun KIM, Suwon-si (KR)

(73) Assignee: Hyundai Motor Company, Seoul (KR)

(21) Appl. No.: 14/144,133

(22) Filed: Dec. 30, 2013

(30) Foreign Application Priority Data
Aug. 9, 2013 (KR) 10-2013-0094810

(51) Int. Cl. B60K 6/547

(52) U.S. Cl. CPC B60K 6/547; Y10S 903/946
USPC 74/661; 180/65.22; 903/946

(57) ABSTRACT

A hybrid power train provided with a double clutch transmission includes: a first clutch and a second clutch configured to connect or cut off selectively rotational power transmitted from an engine; a first input shaft and a second input shaft that are connected to the first clutch and the second clutch to be rotated; a first motor generator that is connected to the first input shaft and provides the rotational power to the first input shaft; and a second motor generator that is connected to the second input shaft and provides the rotational power to the second input shaft.

### CROSS-REFERENCE TO RELATED APPLICATION

The present application claims priority of Korean Patent Application Number 10-2013-0094810 filed Aug. 9, 2013, the entire contents of which application is incorporated herein for all purposes by this reference.

### BACKGROUND OF INVENTION

1. Field of Invention

The present invention relates to a hybrid power train, and more particularly, to a hybrid power train provided with a double clutch transmission, capable of improving fuel ratio by combining a hybrid structure to manual shifting mechanism of a double clutch transmission.

2. Description of Related Art

Recently, a fuel ratio improvement has been further required for replying to a high fuel cost and CO₂ environmental regulations and thus continuous researches and developments of environment vehicles such as electrical vehicles and hybrid vehicles the fuel ratio of which are improved while reducing exhaust amount of hazardous gas, have been made.

However, in case of an electrical vehicle, since the prices of a battery and a motor that are essential for driving the electrical vehicle are very high, the price of the electrical vehicle becomes high, comparing to a general vehicle that uses fossil fuel, and thus the environment vehicles have not been generally used.

Under the current situation as described above, one of the most practical way for improving the fuel ratio of the vehicles is to improve efficiency of an internal combustion engine or increase a power transmission efficiency of a power train system.

Meanwhile, a transmission having the best efficiency of a driving system is a manual transmission, and further a power transmission efficiency of a double clutch transmission (DCT) based on the manual transmission is better than those of an automatic transmission or continuously variable transmission (CVT).

Accordingly, the fuel ratio of a general internal combustion engine may be improved by configuring a transmission in a hybrid type through combining a motor to DCT with excellent efficiency.

Meanwhile, FIG. 1 is a perspective view showing “double clutch transmission for a hybrid vehicle”, disclosed in Korean Laid-Open No. 10-2007-0021558, according to a related art.

According to the related art, a motor 3 is connected to only one of two input shafts 1, 2 wherein the rotation number of the motor is determined as one with respect to a specific speed of a vehicle under the transmission as configured as above, and thus the transmission cannot be avoided to operate at an inefficient section.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention has been made in an effort to solve the problems of the related art.

Various aspects of the present invention provide for a hybrid power train provided with a double clutch transmission, capable of improving fuel ratio by combining a hybrid structure that can use multiply rotational power of an engine and a motor to manual shifting mechanism of a double clutch transmission.

Various aspects of the present invention provide for a hybrid power train that may include: a first clutch and a second clutch configured to connect or cut off selectively rotational power transmitted from an engine; a first input shaft and a second input shaft that are connected to the first clutch and the second clutch to be rotated; a first motor generator that is connected to the first input shaft and provides the rotational power to the first input shaft; and a second motor generator that is connected to the second input shaft and provides the rotational power to the second input shaft.

The first input shaft and the second input shaft may be provided concentrically.

The hybrid power train provided with a double clutch transmission may further include an output shaft provided in parallel to the first input shaft and the second input shaft, and a shifting gear device in which a plurality of gear pairs having different shifting ratios are provided to be meshed on the first input shaft, the second input shaft and the output shaft and which selects the pair of gears corresponding to a driving speed by a shifting mechanism when a vehicle drives and transfers the rotational power transmitted from the first input shaft or the second input shaft to the output shaft with shifting the rotational power.

The shifting gear device may include: a first shifting gear set where a pair of gears are provided to be meshed constantly therewith on the first input shaft and the output shaft; a second shifting gear set where a pair of gears are provided to be meshed constantly therewith on the second input shaft and the output shaft; and a shifting mechanism for selecting the pair of gears of the first shifting gear set or the pair of the second shifting gear set and transferring the rotational power transmitted from the first input shaft or the second input shaft to the output shaft.

A final reduction gear may be provided concentrically on the output shaft and a differential device is provided to be meshed constantly therewith on the final reduction gear.

The first motor generator and the second motor generator may be connected to a battery for receiving the electric power, or configured to generate electricity.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view showing a hybrid transmission according to a related art;

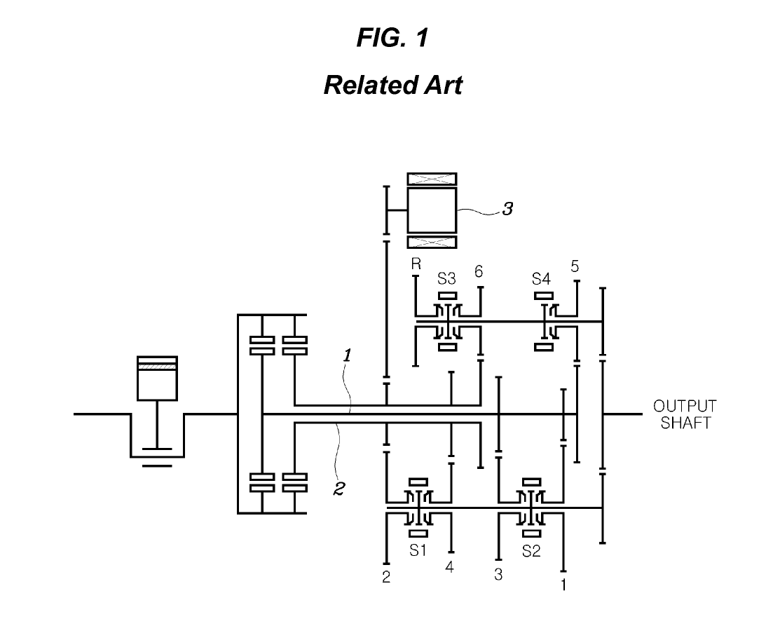

FIG. 2 is a perspective view showing an exemplary hybrid power train according to the present invention;

FIG. 3 is a perspective view showing an exemplary power transferring path on an EV driving mode according to the present invention;

FIG. 4 is a perspective view showing an exemplary power transferring path on a HEV mode according to the present invention;

FIG. 5 is a perspective view showing an exemplary power transferring path on an engine driving mode according to the present invention; and

FIG. 6 is a perspective view showing an exemplary power transferring path on a series driving mode according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

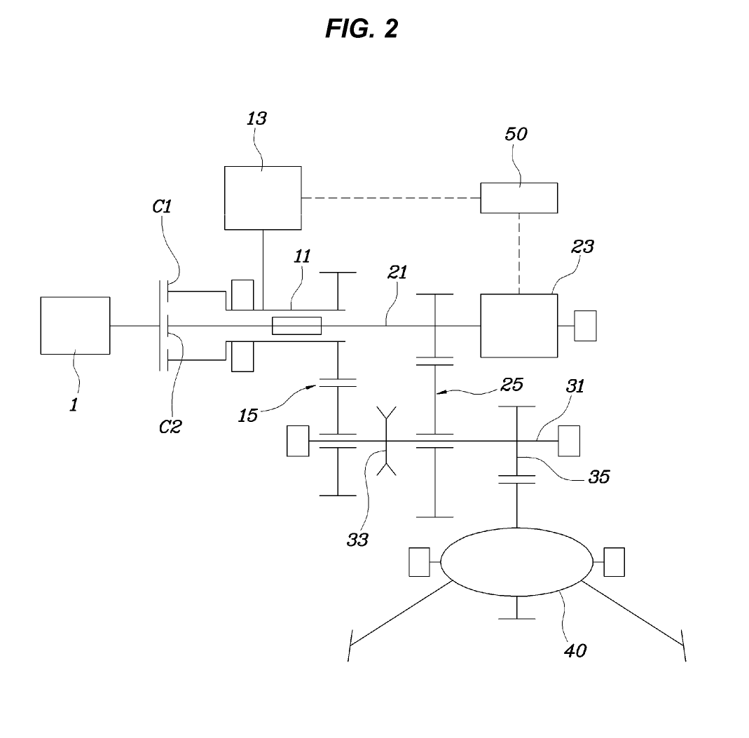

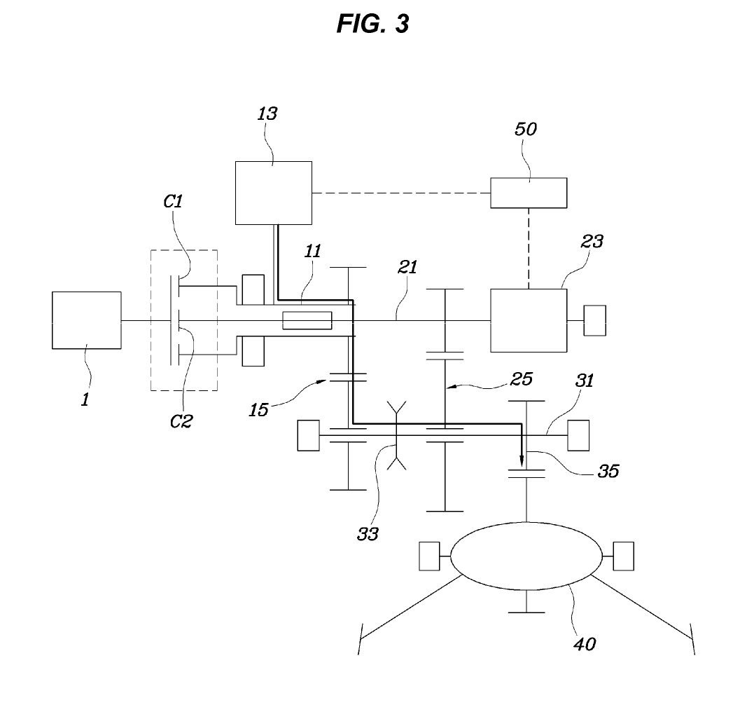

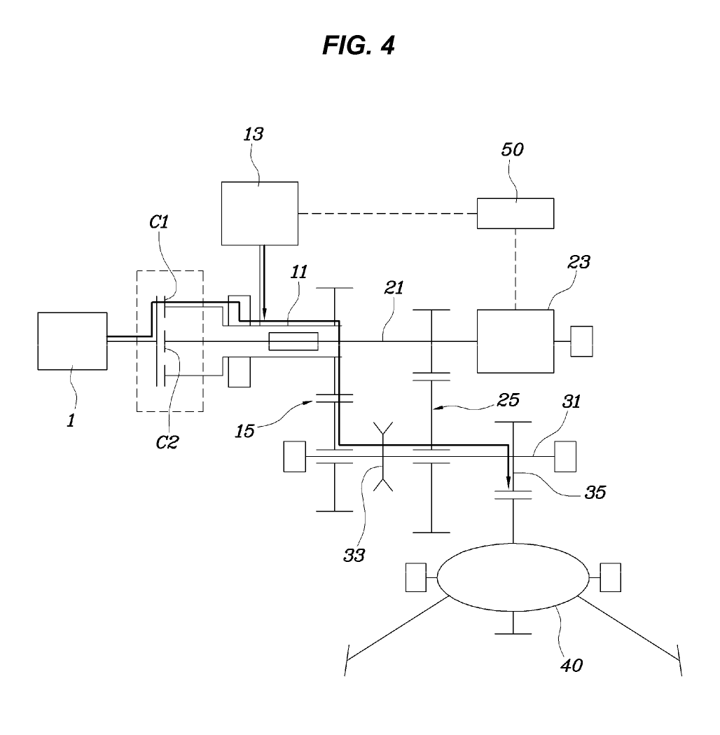

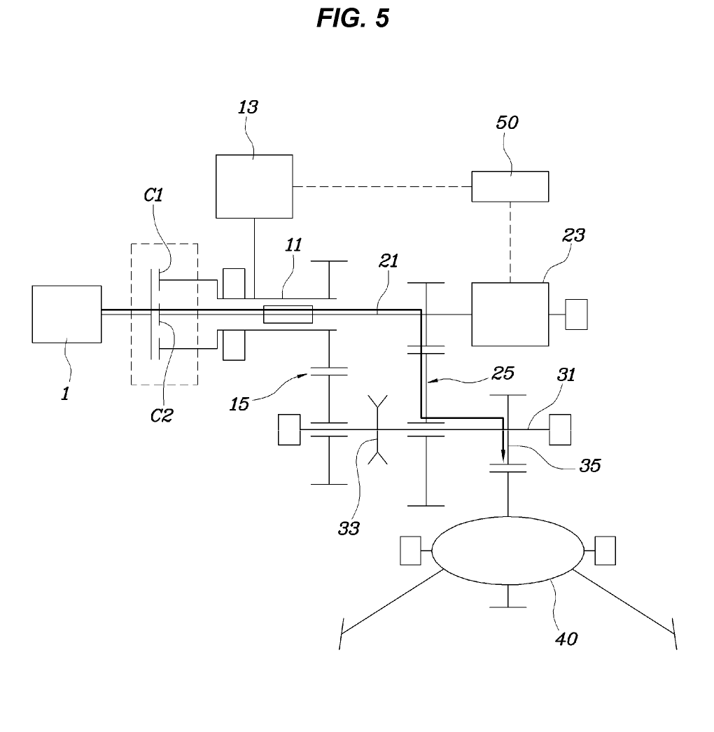

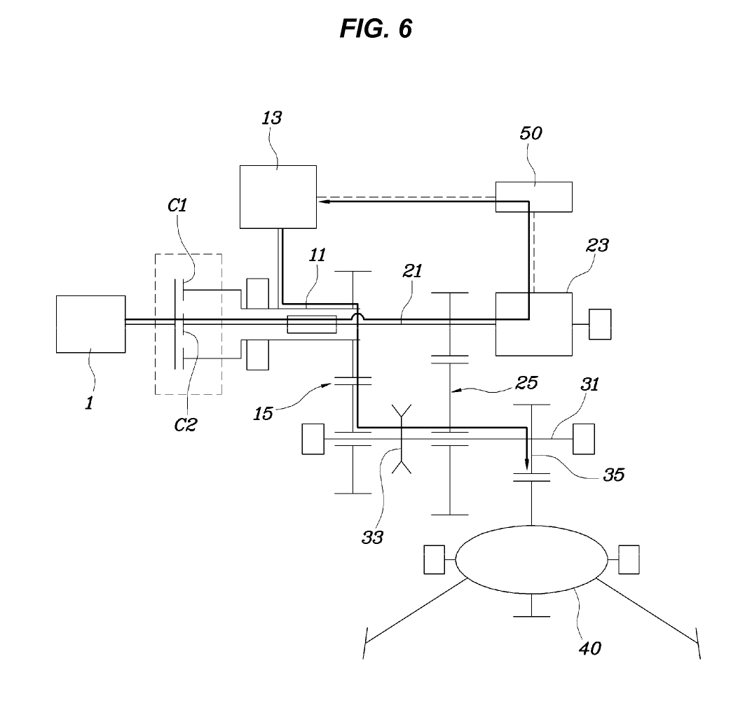

FIG. 2 is a perspective view showing a hybrid power train according to various embodiments of the present invention, FIG. 3 is a perspective view showing a power transferring path on an EV driving mode according to various embodiments of the present invention, FIG. 4 is a perspective view showing a power transferring path on a HEV mode according to various embodiments of the present invention, FIG. 5 is a perspective view showing a power transferring path on an engine driving mode according to various embodiments of the present invention, and FIG. 6 is a perspective view showing a power transferring path on a series driving mode according to various embodiments of the present invention.

A power train provided with a double clutch transmission according to the present invention includes mainly a first clutch C1 and a second clutch C2, a first input shaft 11 and a second input shaft 21, and a first motor generator 13 and a second motor generator 23.

Referring to FIG. 2, the power train provided with a double clutch transmission includes: the first clutch C1 and the second clutch C2 for connecting or cutting off selectively a rotational power transmitted from an engine 1; the first input shaft 11 and the second input shaft 21 that are connected to the first clutch C1 and the second clutch C2 to be rotated; and the first motor generator 13 that is connected to the first input shaft 11 and provides the rotational power thereto and the second motor generator 23 that is connected to the second input shaft 21 and provides the rotational power thereto.

That is, the first motor generator 13 is connected to the first input shaft 11 and the second motor generator 23 is connected to the second input shaft 21, respectively, and the first input shaft 11 and the second input shaft 21 are connected or cut off selectively through the first clutch C1 and the second clutch C2 to transfer the rotation power from an engine 1 wherein a vehicle can drive on various modes through the driving control of the double clutches, the engine 1, and the motor.

Here, the first input shaft 11 and the second input shaft 21 may be provided concentrically in the present invention.

Further, an output shaft 31 may be provided in parallel to the first input shaft 11 and the second input shaft 21. Additionally, a shifting gear device is provided such that a plurality of gear pairs having different shifting ratios are meshed with the first input shaft 11, the second input shaft 21 and the output shaft 31. The shifting gear device transfers the rotation power transmitted from the first input shaft 11 or the second input shaft 21 to the output shaft 31 with shifting the rotation power by selecting the gear pair corresponding to a driving speed through a shifting mechanism 33 when a vehicle drives.

Here, the shifting mechanism 33 may be a synchronizing device in a synchro-mesh type and a configuration of the synchronizing device is well known and thus detailed description thereof is omitted.

Meanwhile, the shifting gear device may include a first shifting gear set 15 where gear pairs that are meshed constantly are arranged on the first input shaft 11 and the output shaft 31; a second shifting gear set 25 where gear pairs that are meshed constantly are arranged on the second input shaft 21 and the output shaft 31; and a shifting mechanism 33 that transfers the rotation power transmitted from the first input shaft 11 or the second input shaft 21 to the output shaft 31 with selecting the gear pair of the first shifting gear set 15 or the gear pair of the second shifting gear set 25.

That is, in the shifting gear device of the present invention, one shifting gear set is arranged on the first input shaft 11 and the output shaft 31, and another shifting gear set is arranged on the second input shaft 21 and the output shaft 31 thereby to simplify at a maximum level a gear configuration of the shifting gear device for implementing manual shifting mechanism and further to improve shifting transferring efficiency and fuel ratio with applying a transmission with a double clutch structure.

Here, the gear arranged to the output shaft 31 among the gear pairs that constitute the first shifting gear set 15 and the second shifting gear set 25 is rotatable relatively with respect to the output shaft 31 wherein the shifting mechanism 33 is arranged on the output shaft 31 between the first shifting gear set 15 and the second shifting gear set 25, and thus the shifting mechanism 33 is moved to the first shifting gear set 15 or the second shifting gear set 25 to be synchronized with the gear arranged on the output shaft 31.

Furthermore, a final reduction gear 35 is arranged concentrically on the output shaft 31 and a differential device 40 may be provided on the final reduction gear 35 to be meshed constantly therewith.

That is, the rotation power transmitted to the output shaft 31 is transferred to the differential device 40 through the final reduction gear 35 thereby to drive a vehicle.

Meanwhile, the first motor generator 13 and the second motor generator 23 are connected to a battery 50 to receive electric power necessary for rotation, or configured to generate electricity.

That is, the engine 1 and the motor as well as the double clutch are driving-controlled by an electronic control unit (ECU) and a telecommunication control unit (TCU) and thus other motor generators can generate electricity using the power from the engine 1 while driving on an EV mode with the motor generators.

A control and power transferring path for transferring power on various driving modes according to the hybrid power train of the present invention will be described.

FIG. 3 is a perspective view showing a power transferring path according to various embodiments of the present invention.

Referring to FIG. 3, the first motor generator 13 is rotated through the battery 50 while releasing all of the first clutch C1 and the second clutch C2. At this time, the shifting mechanism 33 selects the first shifting gear set 5 and is fastened thereto and thus the rotation power of the first motor generator 13 is transferred to the output shaft 31 through the first input shaft 11 and the first shifting gear set 15 thereby to drive a vehicle on an EV mode in which a vehicle drives using only electric power.

Furthermore, the battery 50 can be charged through the second motor generator 23 by connecting the second clutch C2 while driving on EV mode, and further the engine 1 can be started-on using the rotation power of the second motor generator 23 with driving the second motor generator 23 by connecting the second clutch C2 when it intends to change to HEV mode from EV mode.

FIG. 4 is a perspective view showing a power transferring path on a HEV mode according to various embodiments of the present invention.

Referring to FIG. 4, the power from the engine 1 is transferred to the first input shaft 11 by connecting the first clutch C1 and the first motor generator 13 is driven to rotate to transfer the rotation power of the motor generator 13 to the first input shaft 11 together. At this time, the shifting mechanism 33 selects the first shifting gear set 15 and fastened thereto and thus the rotation powers of the engine 1 and the first motor generator 13 are transferred to the output shaft 31 through the first input shaft 11 and the first shifting gear set 15 thereby to drive a vehicle on an HEV mode in which a vehicle drives using combination of engine power and electric power.

FIG. 5 is a perspective view showing a power transferring path on an engine 1 driving mode according to various embodiments of the present invention.

Referring to FIG. 5, the power from the engine 1 is transferred to the second input shaft 21 by connecting the second clutch C2. At this time, the shifting mechanism 33 selects the second shifting gear set 25 and fastened thereto and thus the rotation power of the engine 1 is transferred to the output shaft 31 through the second input shaft 21 and the second shifting gear set 25 thereby to drive a vehicle on an engine 1 driving mode in which a vehicle drives using engine power.

FIG. 6 is a perspective view showing a power transferring path on a series driving mode according to various embodiments of the present invention.

Referring to FIG. 6, the power from the engine 1 is transferred to the second input shaft 21 by connecting the second clutch C2 and the first motor generator 13 is driven through the battery 50 to transfer the rotation power to the first input shaft 11. At this time, the shifting mechanism 33 selects the first shifting gear set 15 and fastened thereto wherein the rotation power of the engine 1 is transferred to the second motor generator 23 to charge the battery 50. Accordingly, a vehicle can drive on a series driving mode in which a vehicle drives using electric power while charging the battery 50 using the power from the engine 1.

Here, the power transferring paths shown in FIGS. 3 to 6 are provided only for helping to understand the present invention and thus the power transferring path can be varied through the driving control of the double clutch, the engine 1 and the motor generator.

According to the present invention, a vehicle can drive on various driving modes through configuring a hybrid structure in which motor generators are mounted to the respective input shafts of a manual shifting mechanism of a double clutch, and controlling to drive the double clutch, the engine and the motor generator. Further, the gear configuration of the shifting gear device is simplified to improve a shifting efficiency and fuel ratio.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. A hybrid power train provided with a double clutch transmission (DCT), comprising:
a first clutch and a second clutch configured to selectively connect or cut off rotational power transmitted from an engine;
a first input shaft and a second input shaft connected to the first clutch and the second clutch to be rotated;
a first motor generator connected to the first input shaft and provides rotational power to the first input shaft; and
a second motor generator connected to the second input shaft and provides rotational power to the second input shaft.

2. The hybrid power train of claim 1, wherein the first input shaft and the second input shaft are concentric.

3. The hybrid power train of claim 1, further comprising:
an output shaft provided in parallel to the first input shaft and the second input shaft; and
a shifting gear device in which a plurality of gear pairs having different shifting ratios are provided to be meshed on the first input shaft, the second input shaft and the output shaft and which selects the pair of gears corresponding to a driving speed by a shifting mechanism when a vehicle drives and transfers the rotational power transmitted from the first input shaft or the second input shaft to the output shaft with shifting the rotational power.

4. The hybrid power train of claim 3, wherein the shifting gear device comprises:
a first shifting gear set where a pair of gears are provided to be meshed constantly therewith on the first input shaft and the output shaft;
a second shifting gear set where a pair of gears are provided to be meshed constantly therewith on the second input shaft and the output shaft; and
a shifting mechanism for selecting the pair of gears of the first shifting gear set or the pair of the second shifting gear set and transferring the rotational power transmitted from the first input shaft or the second input shaft to the output shaft.

5. The hybrid power train of claim 3, wherein a final reduction gear is provided concentrically on the output shaft and a differential device is provided to be meshed constantly therewith on the final reduction gear.

6. The hybrid power train of claim 1, wherein the first motor generator and the second motor generator are connected to a battery for receiving the electric power, or configured to generate electricity.
